(19) United States
(12) Patent Application Publication
(10) Pub. No.: US 2026/0094297 A1
(43) Pub. Date: Apr. 2, 2026

(54) DEVICE AND METHOD WITH KEY POINT DETECTION

(71) Applicant: Samsung Electronics Co., Ltd., Suwon-si (KR)

(72) Inventors: Jiayang WANG, Xi’an (CN); Zidong GUO, Xi’an (CN); Zhaohui LV, Xi’an (CN); Dae Hyun JI, Suwon-si (KR); Dongwook LEE, Suwon-si (KR); Paulbarom JEON, Suwon-si (KR); Han XU, Xi’an (CN); Ran YANG, Xi’an (CN)

(73) Assignee: Samsung Electronics Co., Ltd., Suwon-si (KR)

(21) Appl. No.: 19/270,108

(22) Filed: Jul. 15, 2025

(30) Foreign Application Priority Data
Sep. 27, 2024 (CN) 202411358546.4
Mar. 17, 2025 (KR) 10-2025-0034197

(51) Int. Cl. G06T 7/73

(52) U.S. Cl. CPC G06T 7/73; G06T 2207/20084

(57) ABSTRACT

The present disclosure relates to a device and method of detecting a key point. The method includes obtaining an initial detection result and first variance information of a key point of a target object in an image, performing key point verification on the initial detection result based on the first variance information, and determining a detection result of the target object based on a verification result of the key point.

### CROSS-REFERENCE TO RELATED APPLICATIONS

This application claims the benefit under 35 USC § 119 (a) of Chinese Patent Application No. 202411358546.4 filed on Sep. 27, 2024, in the China National Intellectual Property Administration, and Korean Patent Application No. 10-2025-0034197, filed on Mar. 17, 2025, in the Korean Intellectual Property Office, the entire disclosures of which are incorporated herein by reference for all purposes.

### BACKGROUND

### 1. Field

The following embodiment relates to a computer vision field, and more specifically, to a method and device with detection of a key point of a target object.

### 2. Description of Related Art

Key point detection is one of the popular and important research topics in the computer vision field and aims to detect all object instances in an image and identify key points (e.g., joint points of a human body) of each object. Key point detection is used in a wide range of application fields, such as motion recognition and human-computer interaction.

Currently, various human pose-estimation methods have been proposed, but these methods have problems of low estimation accuracy, slow detection speed, and an inability to prevent detection interference in a complex scene (e.g., a complex scene with many people).

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

The present disclosure is to provide a method and device for detecting a key point.

In one general aspect, a method of detecting a key point includes obtaining both an initial detection result of detecting a target object in an image and first variance information of a key point of the target object in the image, performing key point verification on the initial detection result, wherein the key point verification is performed based on the first variance information, and determining an initial detection result of the target object based on a verification result of the key point, wherein the initial detection result includes position information of the key point verification.

The performing of the key point verification on the initial detection result based on the first variance information includes generating a mask matrix for the determining of the key point based on the first variance information, and determining a first key point of the target object based on the mask matrix and the initial detection result.

The obtaining of the initial detection result and the first variance information of the key point of the target object includes obtaining a target image block from the image, the target image block including the target object, obtaining feature information of the target image block by performing feature extraction on the target image block, and obtaining the initial detection result and the first variance information of the key point of the target object based on the obtained feature information.

The obtaining of the initial detection result and the first variance information of the key point of the target object based on the feature information includes predicting first position-related information of the key point of the target object by using a first neural network, based on at least one feature of the feature information, and predicting the initial detection result and the first variance information of the key point of the target object by using a second neural network, based on the first position-related information and the at least one feature.

The second neural network includes a first self-attention network, a cross-attention network, a first position prediction network, and a first variance prediction network, and the predicting of the initial detection result and the first variance information of the key point of the target object by using the second neural network, based on the first position-related information and the at least one feature, includes generating a first query vector based on the at least one feature, generating a first feature based on the first query vector and the first position-related information by using the first self-attention network, generating a second feature based on the first feature and the at least one feature by using the cross-attention network, and predicting the initial detection result and the first variance information based on the second feature by using the first position prediction network and the first variance prediction network.

The determining of the detection result of the target object based on the verification result of the key point includes obtaining a target image block including the target object from the image, obtaining feature information of the target image block by performing feature extraction on the target image block, and predicting position information of a final key point of the target object by using a third neural network, based on the feature information, the initial detection result, and the first key point.

The third neural network includes a second self-attention network, a deformable attention network, a second position prediction network, and a second variance prediction network, and the predicting of the position information of the final key point of the target object by using the third neural network, based on the feature information, the initial detection result, and the first key point, includes generating a third feature by using the second self-attention network, based on the first key point, second position-related information output by the second neural network, and a second query vector, generating a fourth feature by using the deformable attention network, based on the third feature, the feature information, and the initial detection result, and predicting the position information of the final key point of the target object based on the fourth feature by using the second position prediction network and the second variance prediction network.

The predicting of the position information of the final key point of the target object based on the fourth feature by using the second position prediction network and the second variance prediction network includes obtaining position information of the key point of the target object based on the fourth feature by using the second position prediction network, obtaining second variance information of the key point of the target object based on the fourth feature by using the second variance prediction network, and determining the final key point of the target object based on a comparison between the second variance information and a threshold value and obtaining the position information of the final key point of the target object from the final key point of the target object.

The second neural network includes neural network units connected in series with each other, each of the neural network units includes the first self-attention network, the cross-attention network, the first position prediction network, and the first variance prediction network, an input to a first neural network unit of neural network units includes the first position-related information, the at least one feature, and the first query vector, an output of the first neural network unit includes position-related information as an intermediate value, a query vector, and position information and variance information of the key point, and in the neural network units, a following neural network unit of the first neural network unit uses an output of a previous neural network unit as an input and performs an operation until a last neural network unit outputs the initial detection result and the first variance information.

The third neural network includes a plurality of neural network units connected in series, each of the plurality of neural network units includes the second self-attention network, the deformable attention network, the second position prediction network, and the second variance prediction network, an input to a first neural network unit of the plurality of neural network units includes the first key point, the second position-related information, the second query vector, the feature information, and the initial detection result, an output of the first neural network unit includes position-related information as an intermediate value, a query vector, and position information and variance information of the key point, and in the plurality of neural network units, a following neural network unit of the first neural network unit uses an output of a previous neural network unit as an input and performs an operation until a last neural network unit outputs a final detection result.

In another general aspect, a non-transitory computer-readable storage medium stores instructions that, when executed by a processor, cause the processor to perform the method.

In another general aspect, an electronic device for detecting a key point includes one or more processors, and memory storing instructions, wherein the instructions, when executed by the one or more processors, cause the electronic device to obtain an initial detection result and first variance information of a key point of a target object in an image, perform key point verification on the initial detection result based on the first variance information, and determine a detection result of the target object based on a verification result of the key point, wherein the initial detection result includes position information of the key point.

In another general aspect, a device for detecting a key point includes a data obtainer configured to obtain an initial detection result and first variance information of a key point of a target object in an image, a key point verifier configured to perform key point verification on the initial detection result based on the first variance information, and a key point determiner configured to determine a detection result of the target object based on a verification result of the key point, wherein the initial detection result includes position information of the key point.

The key point verifier is further configured to generate a mask matrix for determining the key point based on the first variance information, and determine a first key point of the target object based on the mask matrix and the initial detection result.

The data obtainer is further configured to obtain a target image block including the target object from the image, obtain feature information of the target image block by performing feature extraction on the target image block, and obtain the initial detection result and the first variance information of the key point of the target object based on the feature information.

The data obtainer is further configured to, when obtaining the initial detection result and the first variance information of the key point of the target object based on the feature information, predict first position-related information of the key point of the target object by using a first neural network, based on at least one feature of the feature information, and predict the initial detection result and the first variance information of the key point of the target object by using a second neural network, based on the first position-related information and the at least one feature.

The second neural network includes a first self-attention network, a cross-attention network, a first position prediction network, and a first variance prediction network, and the data obtainer is further configured to generate a first query vector based on the at least one feature, generate a first feature based on the first query vector and the first position-related information by using the first self-attention network, generate a second feature based on the first feature and the at least one feature by using the cross-attention network, and predict the initial detection result and the first variance information based on the second feature by using the first position prediction network and the first variance prediction network.

The key point determiner is further configured to obtain a target image block including the target object from the image, obtain feature information of the target image block by performing feature extraction on the target image block, and predict position information of a final key point of the target object by using a third neural network, based on the feature information, the initial detection result, and the first key point.

The third neural network includes a second self-attention network, a deformable attention network, a second position prediction network, and a second variance prediction network, and the key point determiner is further configured to generate a third feature by using the second self-attention network, based on the first key point, second position-related information output by the second neural network, and a second query vector, generate a fourth feature by using the deformable attention network, based on the third feature, the feature information, and the initial detection result, and predict the position information of the final key point of the target object based on the fourth feature by using the second position prediction network and the second variance prediction network.

The key point determiner is further configured to obtain position information of the key point of the target object based on the fourth feature by using the second position prediction network, obtain second variance information of the key point of the target object based on the fourth feature by using the second variance prediction network, and determine the final key point of the target object based on a comparison between the second variance information and a threshold value and obtaining the position information of the final key point of the target object from the final key point of the target object.

Other features and aspects will be apparent from the following detailed description, the drawings, and the claims.

### BRIEF DESCRIPTION OF THE DRAWINGS

FIG. 1 illustrates a method of detecting a key point, according to one or more embodiments.

FIG. 2 illustrates a key point detection structure according to one or more embodiments.

FIG. 3 illustrates an example of a second neural network according to one or more embodiments.

FIG. 4 illustrates an example of a third neural network according to one or more embodiments.

FIG. 5 illustrates an example of detecting a key point according to one or more embodiments.

FIG. 6 illustrates an example of a first neural network according to one or more embodiments.

FIG. 7 illustrates an another example of a second neural network according to one or more embodiments.

FIG. 8 illustrates an another example of a third neural network according to one or more embodiments.

FIG. 9 diagram illustrates a key point detection device according to one or more embodiments.

FIG. 10 illustrates an example of an electronic device for detecting a key point according to one or more embodiments.

Throughout the drawings and the detailed description, unless otherwise described or provided, the same or like drawing reference numerals will be understood to refer to the same or like elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known after an understanding of the disclosure of this application may be omitted for increased clarity and conciseness.

The features described herein may be embodied in different forms and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

The terminology used herein is for describing various examples only and is not to be used to limit the disclosure. The articles “a,” “an,” and “the” are intended to include the plural forms as well, unless the context clearly indicates otherwise. As used herein, the term “and/or” includes any one and any combination of any two or more of the associated listed items. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof.

Throughout the specification, when a component or element is described as being “connected to,” “coupled to,” or “joined to” another component or element, it may be directly “connected to,” “coupled to,” or “joined to” the other component or element, or there may reasonably be one or more other components or elements intervening therebetween. When a component or element is described as being “directly connected to,” “directly coupled to,” or “directly joined to” another component or element, there can be no other elements intervening therebetween. Likewise, expressions, for example, “between” and “immediately between” and “adjacent to” and “immediately adjacent to” may also be construed as described in the foregoing.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

Unless otherwise defined, all terms, including technical and scientific terms, used herein have the same meaning as commonly understood by one of ordinary skill in the art to which this disclosure pertains and based on an understanding of the disclosure of the present application. Terms, such as those defined in commonly used dictionaries, are to be interpreted as having a meaning that is consistent with their meaning in the context of the relevant art and the disclosure of the present application and are not to be interpreted in an idealized or overly formal sense unless expressly so defined herein. The use of the term “may” herein with respect to an example or embodiment, e.g., as to what an example or embodiment may include or implement, means that at least one example or embodiment exists where such a feature is included or implemented, while all examples are not limited thereto.

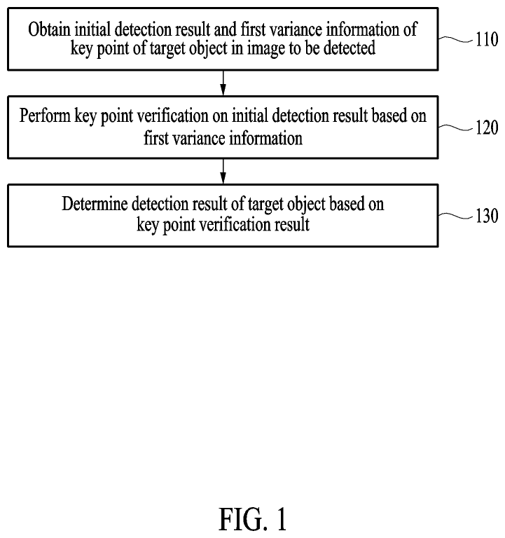

FIG. 1 illustrates a method of detecting a key point, according to one or more embodiments.

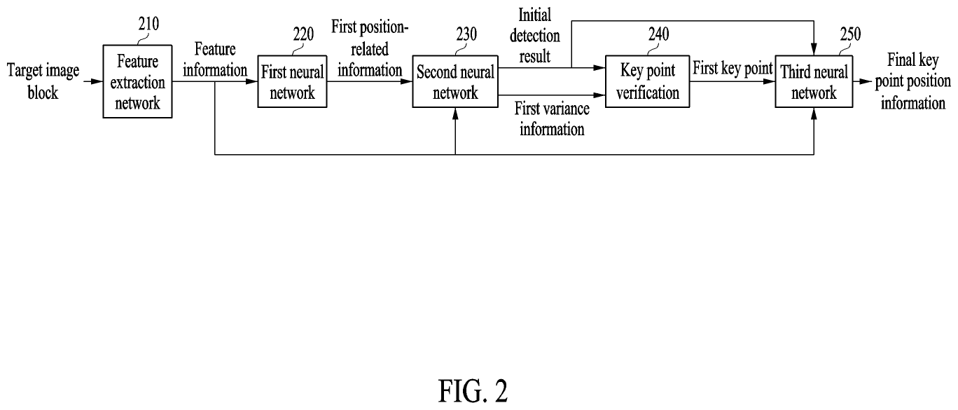

FIG. 2 illustrates a key point detection structure according to one or more embodiments.

Hereinafter, a method of detecting a key point of the present disclosure is described with reference to FIGS. 1 and 2.

In operation 110, a key point detection device may obtain an initial detection result and first variance information of a key point of a target object of an image. In this case, the initial detection result may include position information of a key point. For example, the initial detection result may show which key point is detected and position information of the key point. The position information may be coordinate information.

For example, the image subject to detection may be a single image or a specific frame of a video. The target object may be each human body or object in the image. Identifying a posture or a shape of the target object by detecting a key point (or a joint point) of the target object may be used for applications, such as following motion recognition or human-computer interaction.

For example, the key point detection device may obtain a target image block of the image subjected to object detection (“image” for short). In this case, the target image block may include at least the target object. The key point detection device may obtain feature information of the target image block by extracting a feature from the target image block and may obtain the initial detection result and the first variance information of the key point of the target object. For example, when one or more human bodies are included in the image, the key point detection device may obtain human body frames (e.g., bounding boxes of respective human bodies) in the image through any human body detection network (e.g., a network trained with images of human bodies). In this case, each human body frame (or bounding box) may be the target image block (a block/box may not necessarily encompass all of the corresponding human body). For each target image block, a feature extraction network 210 may extract the corresponding feature information from the target image block by using the target image block as an input (e.g., directly input or normalize the target image block in an img format image of size W×H×3) to the feature extraction network 210. An extracted feature may be multi-scale feature information (in other words, multi-scale feature representation) and the number of multi-scales may be adjusted depending on the actual needs and network structure. For example, the key point detection device may extract feature representations at four scales. The feature extraction network 210 may be at least one of a residual network (ResNet), a high-resolution network (HRNet), or a high-resolution transformer (HRFormer).

After obtaining the feature information of the target image block, the key point detection device may predict information related to a first position (hereinafter, also referred to as the first position-related information) of the key point of the target object based on at least one feature of the feature information by using a first neural network 220 and may predict the initial detection result and the first variance information of the key point of the target object based on the first position related information and the at least one feature by using a second neural network 230. For example, at least one feature of the feature information may be feature information at the smallest scale among the extracted multi-scale feature information. The first position-related information may be coordinates of the key point of the target object or a position vector obtained by applying position encoding to the coordinates, and the first variance information may include a variance with respect to horizontal and vertical coordinates of the key point of the target object.

Based on the assumption that feature representations at four scales of the target image block are extracted, one (e.g., a feature with the smallest size) of the feature representations may be used as an input to the first neural network 220 and the information (e.g., coordinate information of the key point) related to the first position of the target object may be obtained. For example, the first neural network 220 may include a global average pooling (GAP) layer and a fully connected (FC) layer. However, the above example is only an example, and the first neural network 220 in the present disclosure may be any neural network that may extract the information related to the first position of the key point of the target object from the image. In addition, two or more (or all) of the multi-scale feature representations may be used as the input to the first neural network 220.

In addition, the first neural network 220 may be divided into two parts. The first part may be used to predict the information (e.g., the coordinate information of the key point) related to the first position of the key point of the target object and the second part may be used to predict the information about the variance of the key point of the target object. For example, each part may include a GAP layer and an FC layer. In a training step, the first neural network 220 may be trained using both the first position-related information and the variance information and in an inference step, only the first position-related information output by the first neural network 220 may be used.

The second neural network 230 may be used to modify a key point having a large error in initial positioning. The second neural network 230 may include at least a first self-attention network, a cross-attention network, a first position prediction network, and a first variance prediction network.

The second neural network 230 may generate a second query vector based on at least one feature of the feature information. A first feature may be generated using the first self-attention network, based on the first query vector and the first position-related information. Also, the second neural network 230 may generate a second feature by using the cross-attention network, based on the first feature and the at least one feature. In addition, the second neural network 230 may predict an initial detection result by using the first position prediction network, based on the second feature, and may predict the first variance information by using the first variance prediction network.

For example, for the feature with the smallest size (mentioned above), the second neural network 230 may change the number of channels to 256 through a 1×1 convolution operation, perform a flatten operation thereon, reshape a flattened feature into a feature of which a dimension is [1, 64×48, 256], and may either (i) generate the first query vector by using the processed feature or may (ii) obtain the first query vector by vector encoding using the processed feature. The second neural network 230 may generate a query (q), a key (k), and a value (v) input to the first self-attention network based on the first query vector and the first position-related information and may obtain a first feature via the first self-attention network. The second neural network 230 may generate a second feature by using the cross-attention network, based on the first feature and the processed feature (in other words, the processed smallest scale feature). The second neural network 230 may predict an initial prediction result by using the first position prediction network, based on the second feature. In this case, the initial prediction result may include the coordinate information of an object key point. The second neural network 230 may predict the first variance information of the key point of the object by using the first variance prediction information, based on the second feature.

In addition, the second neural network 230 may output a query vector and a position encoding vector and may use the query vector and the position encoding vector for a following task. For example, the query vector (a second query vector, etc., described below) and the position encoding vector (second position-related information, etc., described below) output by the second neural network 230 may be used as an input to a third neural network. For example, the second neural network 230 may obtain a second query vector by performing convolution, flattening, and reshaping on the second feature output by the cross-attention network and may obtain the position encoding vector by performing position encoding on the position information output by the first position prediction network.

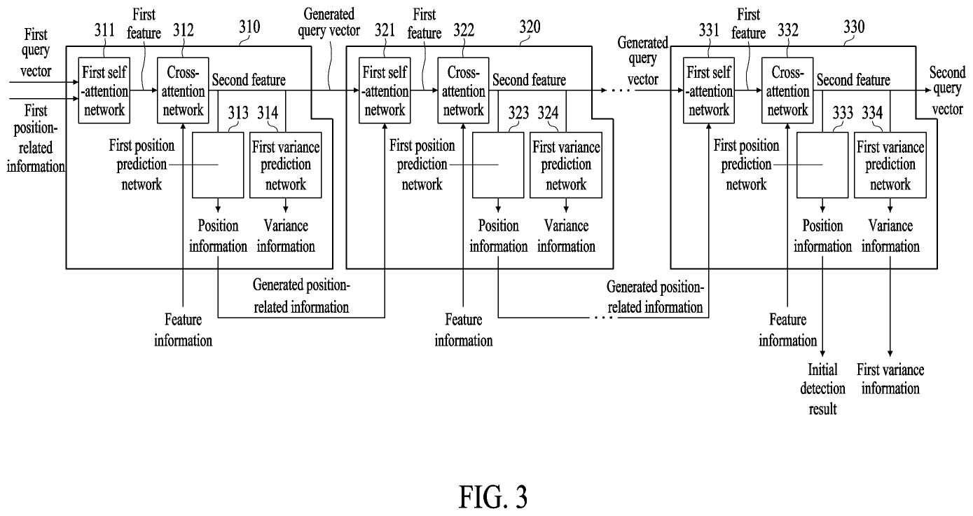

FIG. 3 illustrates an example of a second neural network according to one or more embodiments.

The second neural network 230 of FIG. 3 may include neural network units 310, 320, and 330. The neural network units 310, 320, and 330 may include first self-attention networks 311, 321, and 331, respectively. The neural network units 310, 320, and 330 may further include cross-attention networks 312, 322, and 332, respectively. The neural network units 310, 320, and 330 may include first position prediction networks 313, 323, and 333. The neural network units 310, 320, and 330 may also include first variance prediction networks 314, 324, and 334, respectively. The neural network units 310, 320, and 330 may be connected in series. In this case, an input to the first neural network unit 310 may be first position-related information, at least one feature of feature information, and a first query vector. An output of the first neural network unit 310 may be position-related information (a position encoding vector) as an intermediate value, a query vector, and position information and variance information of a key point. The next neural network unit 320 may use the output of the previous neural network unit as an input and may perform an operation until the last neural network unit 330 outputs an initial detection result and first variance information. In other words, the second neural network 230 may be configured by stacking the neural network units 310, 320, and 330. And, after modifying the position of the key point through the neural network units 310, 320, and 330, the second neural network 230 may use the position-related information output by the last neural network unit 330 of the second neural network 230 as the initial detection result.

Referring to FIG. 3, the second neural network 230 may generate the second query vector based on at least one feature of the feature information extracted from a target image block.

The first neural network unit 310 may generate a first feature by using the first self-attention network 311, based on the first query vector and the first position-related information.

The first neural network unit 310 may generate a second feature by using the cross-attention network 312, based on the first feature and the at least one feature.

The first neural network unit 310 may generate key point position information of a target object by using the first position prediction network 313, based on the second feature and may generate key point variance information of the target object by using the first variance prediction network 314, based on the second feature.

Thereafter, the second neural network unit 320 may generate position-related information by position encoding based on the position information output by the first neural network unit 310 and may generate a query vector by vector encoding based on the second feature. Then, the second neural network unit 320 may input the position-related information and the query vector to a first self-attention network 321 of the second neural network unit 320. In addition, the second neural network unit 320 may input the second feature and the position information to the first self-attention network 321.

The second neural network unit 320 may use feature information extracted from the target image block as the feature information input to the cross-attention network 322. Alternatively, the following neural network unit may use the first feature or the second feature generated by the previous neural network unit.

The last neural network unit 330 may generally function as the previous neural network unit 320.

When the execution of the last neural network unit 330 is completed, the last neural network unit 330 may output the initial detection result (e.g., the coordinates of the key point) of the key point of the target object, the first variance information, and the second query vector. In addition, the second neural network 230 may output the second position-related information by performing position encoding on the position information output by the last neural network unit 330. This output information may be used by a following third neural network 250. When the position-related information is input to third neural network 250, the position information (e.g., coordinates) may be used as a network input.

Returning to the description of FIG. 1, in operation 120, the key point detection device may perform key point verification on the initial detection result based on the first variance information. For example, the key point detection device may ensure the accuracy of key point detection by determining whether to block or complement the key point of the target object by verifying the key point in the initial detection result. The key point detection device may generate a mask by using the first variance information and may remove an influence of an invisible key point on a visible key point during structural prediction.

Specifically, the key point detection device may generate a mask matrix for determining the key point based on the first variance information and may determine a first key point of the target object based on the mask matrix and the initial detection result.

For example, a module for generating the mask matrix may generate the mask matrix Mask based on the first variance information using Equation 1 below.

$$Mask = binary ( ( 1 - repeat ( mean ( {V}_{t} ) , N ) ) + eye , threshold ) \qquad Equation 1$$

In this case, “mean” denotes a mean value of a variance Vₜ in a coordinate dimension, “repeat” denotes repeating a vector N times, N denotes the number of key points, “threshold” denotes a threshold value in a binary operation, “binary” sets the matrix to a matrix in the form of [0, 1] according to the threshold value, and “eye” denotes a unit matrix.

The module for generating the mask matrix may include the third neural network described below, or, the module for generating the mask matrix may be separately provided.

In operation 130, the key point detection device may determine a detection result of the target object based on the key point verification result. For example, the key point detection device may determine a final key point of the target object and a corresponding position.

For example, the key point detection device may predict position information of the final key point of the target object by using the third neural network 250, based on the feature information of the target image block, the initial detection result, and the first key point. A detailed description thereof follows.

For example, before inputting a multi-scale feature (extracted by the feature extraction network 210) to the third neural network 250, the key point detection device may process the multi-scale feature. Using a single-scale feature as an example for description, the key point detection device may change the number of channels to 256 through a 1×1 convolution operation, may flatten a feature of which the number of channels is changed to 256, and may reshape a flattened feature into a feature of which a dimension is [1, 64×48, 256]. Then, the key point detection device may obtain a memory vector (in other words, the feature information of the target image block) including multi-scale information by processing the processed feature at each scale and may use the memory vector as an input to the third neural network 250.

The key point detection device may predict the position information of the final key point of the target object by using the third neural network 250, based on the memory vector, the initial detection result, and the first key point.

For example, the third neural network 250 may include at least a second self-attention network, a deformable attention network, a second position prediction network, and a second variance prediction network. The third neural network 250 may generate a third feature by using the second self-attention network, and may do so based on the second query vector and the second position-related information (e.g., information obtained by encoding key point coordinates predicted by the second neural network 230) output by the second neural network 230, and the first key point. The third neural network 250 may generate a fourth feature by using the deformable attention network, based on the third feature, the feature information (e.g., the memory vector), and the initial detection information. The third neural network 250 may predict the position information of the final key point of the target object by using the second position prediction network and the second variance prediction network, based on the fourth feature. For example, the third neural network 250 may obtain the position information of the key point of the target object by using the second position prediction network, based on the fourth feature, and may obtain the second variance information of the key point of the target object by using the second variance prediction network, based on the fourth feature. The third neural network 250 may determine the final key point of the target object by comparing the second variance information with a threshold value and may obtain the position information of the final key point of the target object.

For example, the third neural network 250 may generate q, k, and v that are inputted to the second self-attention network, and may do so based on the second query vector and the second position-related information output by the second neural network 230. The third neural network 250 may generate the third feature by using the second self-attention network, based on q, k, v, and the first key point. The third neural network 250 may generate the fourth feature by using the deformable attention network, based on the third feature, the feature information, and the initial detection result. The third neural network 250 may obtain the key point position information of the target object by using the second position prediction network module, based on the fourth feature, and may obtain the second variance information of the key point of the target object by using the second variance prediction network, based on the fourth feature. The third neural network 250 may determine the final key point of the target object by comparing the second variance information with a threshold value and may obtain the position information of the final key point of the target object. The third neural network 250 may filter a key point of which a variance is less than the given threshold value by using the preset threshold value and may effectively mask a key point that is invisible or significantly difficult to identify. For example, the threshold value may be set to 0.5. The threshold value may be adjusted according to the actual requirement.

In some embodiments, the third neural network 250 may include multiple neural network units.

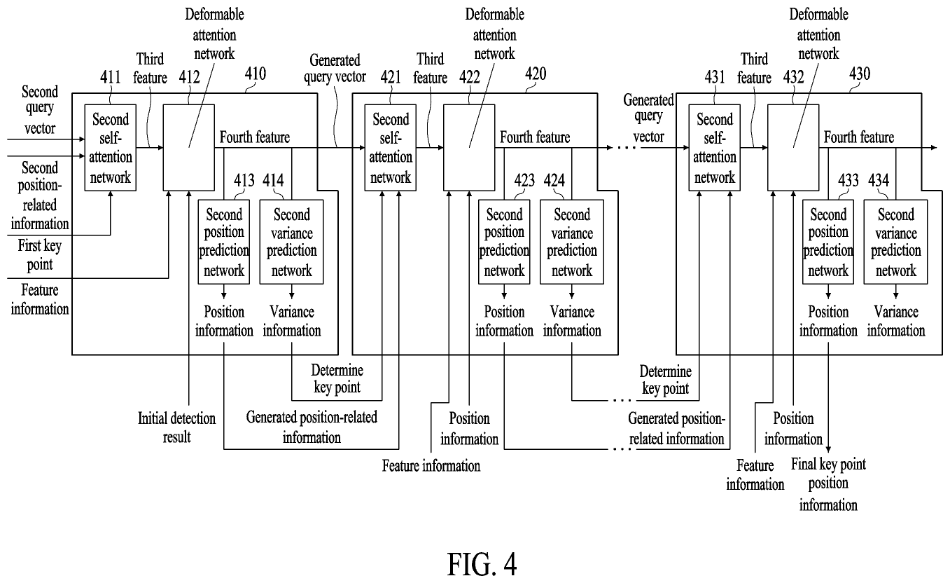

FIG. 4 illustrates an example of a third neural network according to one or more embodiments.

Referring to FIG. 4, the third neural network 250 may include neural network units 410, 420, and 430.

The neural network units 410, 420, 430 may include at least second self-attention networks 411, 421, and 431, deformable attention networks 412, 422, and 432, second position prediction networks 413, 423, and 433, and second variance prediction networks 414, 424, and 434, respectively. The neural network units 410, 420, and 430 may be connected in series. In this case, an input to the first neural network unit 410 may include a first key point, second position-related information (a position encoding vector), a second query vector, feature information, and an initial detection result. An output of the first neural network unit 410 may be position-related information as an intermediate value, a query vector, key point position information, and variance information. The following neural network unit may use an output of the previous neural network unit as an input and may perform an operation until the last neural network unit outputs a final detection result.

The first neural network unit 410 may obtain a third feature by using the second self-attention network 411, based on the first key point, the second position-related information (the position encoding vector), and the second query vector. The first neural network unit 410 may generate a fourth feature by using the deformable attention network 412, based on the third feature, the feature information, and the initial detection result. The first neural network unit 410 may generate the position information by using the second position prediction network 413, based on the fourth feature, and may generate the variance information by using the second variance prediction network 414.

The third neural network 250 may generate the position-related information by position encoding based on the position information output by the first neural network unit 410. The key point may be determined by the mask matrix-based key point determination method described above based on the variance information and the position information output by the first neural network unit 410. The third neural network 250 may generate a query vector by vector encoding based on the fourth feature.

The third neural network 250 may input the query vector, the key point, and the position-related information output by the first neural network unit 410 to the second self-attention network 421 of the second neural network unit 420.

The second neural network unit 420, which is an intermediate neural network unit, may use the feature information extracted from the target image block as the feature information input to the deformable attention network 422 or may use the third or fourth feature output by the previous neural network unit. The position information input to the deformable attention network 422 may be the initial detection result or the position information output by the previous neural network unit.

The last neural network unit 430 may output the position information of a final key point of the target object.

The variance information may be used as a criterion for determining whether a key point exists or is valid. For example, when the variance of a key point is greater than a threshold value, it may be considered that the key point does not exist, and when the variance of a key point is less than the threshold value, it may be considered that the key point exists. This may enable more accurate recognition of a key point of the target object.

Thereafter, the third neural network 250 may complete key point detection of the image by mapping final key point coordinates of the target object to the image according to the coordinates of the target image block in the image.

For example, when a specific body part in an image being subjected to human pose estimation is occluded by another body part, a key point of the occluded part may be accurately identified by using the key point detection methods of described herein. In addition, the methods may improve the accuracy of the recognition result because position determination of a specific part is not unnecessarily affected by the movement of the position of another part.

In some embodiments, the last neural network unit 430 of the third neural network 250 may not include the second variance prediction network 434 and may directly output the key point position information of the target object and use the key point position information of the target object as the final recognition result.

In addition, a method of training a neural network may be supervised using a residual logarithmic likelihood estimation (RLE) loss. In this case, key point coordinates R may be fully supervised learning, variance V may be self-adaptive learning, and a key point that does not exist due to occlusion or other reasons may not be included in the loss calculation. A loss function may be configured based on real data (e.g., a real or ground truth key point position) corresponding to the output of the first neural network 220, the output of the second neural network 230, and the output of the third neural network 250, and a parameter of the neural network may be trained by adjusting parameters of the neural network to minimize the configured loss function. However, the training method is an example, and the present disclosure is not limited thereto.

The key point detection (e.g., human pose estimation) method of a deformable mask decoder network based on variance constraints proposed herein may remove the influence of an occluded key point on a visible key point in structural prediction and may thus improve the accuracy of human pose estimation.

In some embodiments, key point detection may be performed on all target objects of an image or video. For example, when detecting a key point of a person in an image or video, after all human body frames (e.g., bounding boxes of respective detected human bodies) are obtained from the image by an object detection network, key point coordinates of each human body/frame may be predicted using the key point detection methods described herein, and the key point coordinates of the human body may be mapped to the image according to the coordinates of each human frame in the image being subjected to detection.

An object frame may be detected/cropped from an image or video by using any target object method/model for detecting the target object in the image or video. All human body frames in the image may be detected/cropped as a target image block by using any human body detection method.

Based on the assumption that the target image block is an image block including a target human body, when the target image block is cropped to fit/bound the human body frame, for each detected human frame (or coordinate frame), the human body frame may not completely surround the edge of the human body because of an error in an output of the object detection model/object detection network, and thus, the target object detection method/model may expand the human body frame to include a wider human body area.

For example, the target object detection method/model may enlarge the human body frame by 1.25 times. Thereafter, the target object detection method/model may replace an image area other than the enlarged human body frame with 0 (in other words, removing an irrelevant interference element) and fill a short side of the human body frame to satisfy an aspect ratio of an input to the following key point detection network (e.g., a single person key point detection network, etc.). Lastly, the target object detection method/model may crop the image based on the processed human body frame and may adjust the cropped target image block to a preset size, such as 256×192. In this case, when the aspect ratio of the human body frame is equal to the aspect ratio of the single person key point detection network or the size of the cropped image block satisfies the preset size, there may be no need to fill the short side of the human body frame or adjust the size of the image block.

After obtaining the target image block, the key point of the target object may be detected using the key point detection methods.

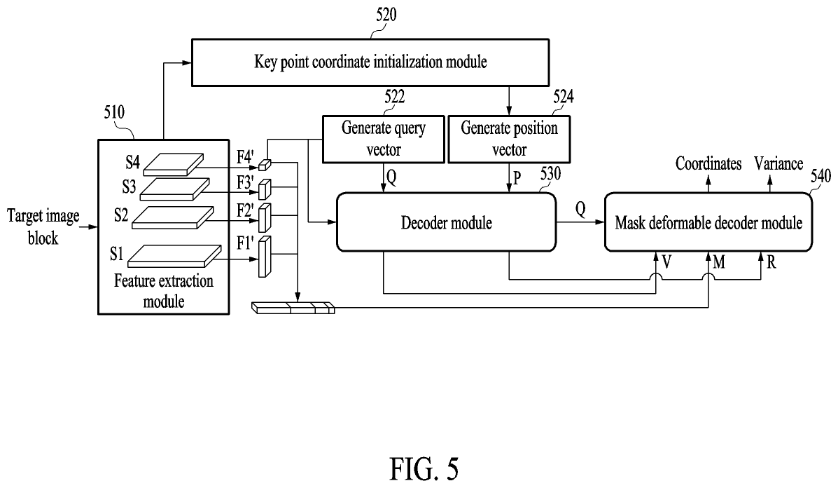

FIG. 5 illustrates an example of detecting a key point according to one or more embodiments.

Next, a description is provided using an example of estimating a key point of a human body in an image or video.

Referring to FIG. 5, a key point estimation method may be implemented mainly in four parts, a feature extraction module (backbone) 510, a key point coordinate initialization module (key point coords init module) 520, a decoder module 530, and a mask deformable decoder module 540. In this case, the feature extraction module 510 may correspond to the feature extraction network 210 described above, the key point coordinate initialization module 520 may correspond to the first neural network 220 described above, the decoder module 530 may correspond to the second neural network 230 described above, and the mask deformable decoder module 540 may correspond to the third neural network 250 described above. Operations performed by each module are now described.

The feature extraction module 510 may provide a multi-scale feature representation of an input image by extracting a feature from the input image (e.g., a target image block). The number of scales of the multi-scale feature may be adjusted according to the actual requirement and the network structure. For example, the number of scales of the multi-scale feature may be four, depending on the structure of the selected feature extraction module 510 (e.g., ResNet, HRNet, HRFormer, etc.). An input to the feature extraction module 510 may be a normalized image (e.g., a processed target image block) normalized to a size of W×H×3, and an output may be multi-scale feature vectors S1 to S4; S1 to S4 having different sizes/scales.

For example, the multi-scale features S1 to S4 of the input image may be extracted by the feature extraction module 510 by inputting the scaled target image block shown in FIG. 5 to the feature extraction module 510. Taking ResNet50 as an example, when the size of the input image is 256×192, an output feature for the scales may be S1 [1, 256, 64, 48], S2 [1, 512, 32, 24], S3 [1, 1024, 16, 12], S4 [1, 2048, 8, 6], respectively.

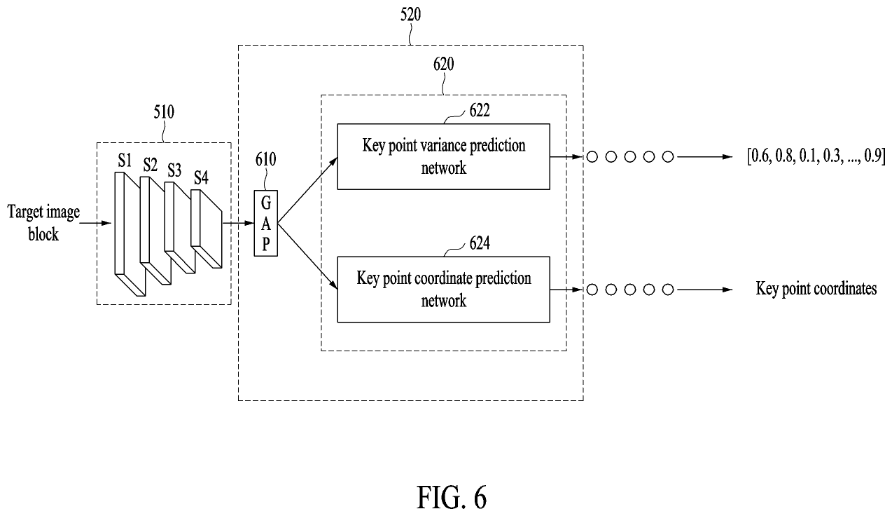

The key point coordinate initialization module 520 may include a GAP layer and an FC layer and may be used for initial pose estimation. For example, the key point coordinate initialization module 520 may predict a position R¹ of a key point of the target object and a variance V¹ on the horizontal and vertical coordinates, based on one or more scale features of multi-scale features. The key point coordinate initialization module 520 is described below with reference to FIG. 6.

The decoder module 530 may include a stack of decoders (e.g., a transformer) and may serve to modify a key point with a large error in initial position estimation. In this case, each decoder may correspond to one of the neural network units 310, 320, and 330 of the second neural network 230 described above.

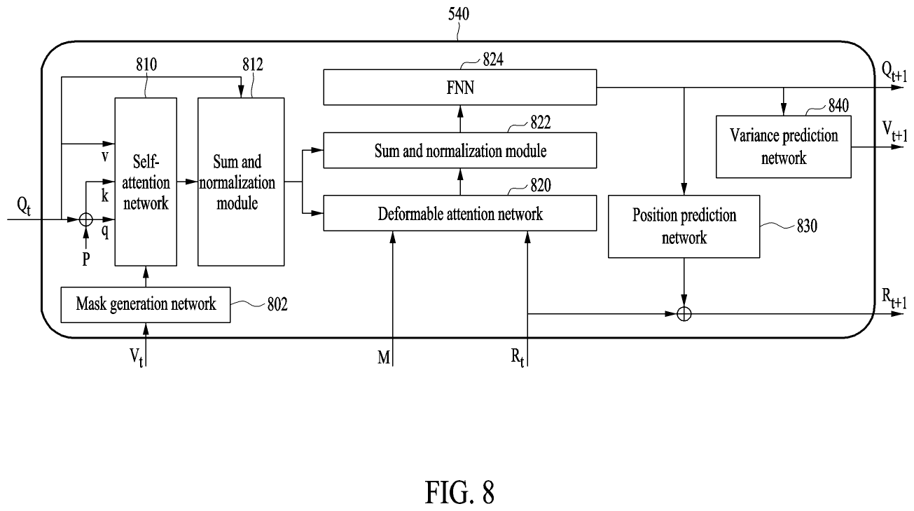

The mask deformable decoder module 540 may include stacked neural network units. The mask deformable decoder module 540 may learn a structured feature while simultaneously receiving multi-scale information and may obtain a key point position by reducing an adverse effect of an invisible/occluded point by generating a constrained mask by key point variance. The mask deformable decoder module 540 is described below with reference to FIG. 8.

The key point estimation method may process the multi-scale features S1 to S4 before performing an operation of the decoder module 5300. Taking S1 as an example, the key point estimation method may change the number of channels to 256 through a 1×1 convolution operation, flatten a feature of which the number of channels is changed to 256, and reshape a flattened feature into a feature of which a dimension is [1, 64×48, 256] to obtain processed feature F1′. The key point estimation method may obtain processed features F2′, F3′, and F3′ in the same manner.

The key point estimation method may perform query vector Q generation 522, which is a partial input to the decoder module 530 and position vector P generation 524, based on F4′ and R¹. In this case, the query vector Q generation 522 may be performed by 1×1 convolution in F4′. The position vector P generation 524 may be performed by a trigonometric function in R¹. Lastly, the key point detection method may input F4′, P, and Q to the decoder module to learn structural information of a human body and predict a key point offset ΔR and a key point variance V² based on R¹. Thereafter, the decoder module 530 may calculate modified key point coordinates R² using Equation 2 below.

$${R}^{2} = {R}^{1} Δ R \qquad Equation 2$$

R² is the position information of a modified key point, R¹ is the position information of a key point of the target object, and ΔR is a key point offset.

Optionally, the decoder module 530 may directly output the modified key point coordinates and variance without the calculation according to Equation 2. The numbers provided with R¹, R², V¹ and V² may be used only to distinguish between previous prediction information and current prediction information. When there are multiple neural network units, an output of the previous neural network may be used as an input to the following neural network.

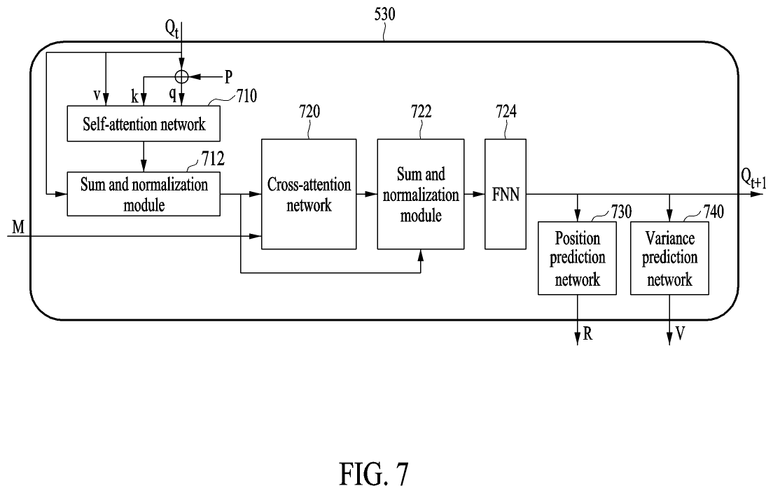

The key point estimation method may configure a memory vector including the multi-scale information by concatenating F1′, F2′, F3′, F4′ vectors and may use the memory vector as an input M to the mask deformable decoder module 540. The decoder module 530 is described below with reference to FIG. 7.

FIG. 6 illustrates an example of a first neural network according to one or more embodiments.

In this case, the first neural network 220 of FIG. 6 may correspond to the key point coordinate initialization module 520 and the key point coordinate initialization module 520 may be used to predict the variance information and the coordinate information (in other words, the position information) of a key point.

Referring to FIG. 6, after the key point coordinate initialization module 520 receives the multi-scale features S1 to S4 via the feature extraction module 510, the key point coordinate initialization module 520 may predict the variance information and the coordinate information of an object based on the smallest scale feature S4. For example, the key point coordinate initialization module 520 may obtain the variance information V¹ and the position information R¹ of the key point by inputting S4 to a GAP layer 610 and then inputting S4 to an FC layer 620 (e.g., a key point variance prediction network 622 and a key point coordinate prediction network 624). The example of FIG is only an example, and the present disclosure is not limited thereto.

FIG. 7 illustrates an another example of a second neural network according to one or more embodiments.

In this case, the second neural network 240 of FIG. 7 may correspond to the decoder module 530. Although FIG. 7 illustrates only one neural network unit, a plurality of neural network units may be stacked to implement the second neural network 240. In the case of multiple, each neural network unit may include a self-attention network 710, a cross-attention network 720, a position prediction network 730, and a variance prediction network 740.

Referring to FIG. 7, the decoder module 530 may generate inputs v, k, and q to the self-attention network 710 based on a query vector Qₜ and a position vector P. In this case, when multiple neural network units are stacked, for the first neural network unit, Qₜ may be a query vector generated by F4′ through 1×1 convolution and P may be a position vector generated by R¹ through a trigonometric function. For the second neural network unit, Qₜ may be a query vector output by the first neural network unit and P may be a position vector obtained by position encoding the position information output by the first neural network unit. In this case, t is the number of neural network units in the decoder module 530; t+1 may correspond to an output of the decoder module 530.

The decoder module 530 may obtain k and q by adding Qₜ to P and may use Qₜ as v. Thereafter, a sum and normalization module 712 may add an output of the self-attention network 710 to Qₜ and normalize it, and may input the normalized result and F4′ to the cross-attention network 720. The sum and normalization module 722 may add an output of the cross-attention network 720 to the normalized result and normalize it again to input to a feedforward neural network (FNN) 724. The FNN 724 may receive the output of the sum and normalization module 722, may generate and provide a query vector Qₜ₊₁ to the position prediction network 730 and the variance prediction network 740. The position prediction network 730 may obtain the position information of the key point by receiving the query vector Qₜ₊₁. In addition, the variance prediction network 740 may obtain the variance information of the key point by receiving the query vector Qₜ₊₁.

The decoder module 530 may include neural network units and each of the neural network units may include at least a self-attention network 710, a cross-attention network 720, a position prediction network 730, and a variance prediction network 740. The neural networks may be connected in series. An input to the first of the neural network units may be a query vector generated by F4′ through 1×1 convolution and a position vector generated by F4′ and R¹ by a trigonometric function. In addition, an output of the first neural network unit may be position-related information (e.g., the position vector/position encoding), a query vector, and position information and variance information of the key point. The following neural network unit may perform an operation by using the output of the previous neural network unit until the last neural network unit outputs the position information and the variance information of the key point. The network structure shown in FIG. 7 is an example, and the present disclosure is not limited thereto.

FIG. 8 illustrates an another example of a third neural network according to one or more embodiments.

In this case, the third neural network 250 of FIG. 8 may correspond to the mask deformable decoder module 540. Although FIG. 8 illustrates only one neural network unit, multiple neural network units may be stacked to implement the third neural network 250. Each neural network unit may include a self-attention network 810, a cross-attention network 820, a position prediction network 830, and a variance prediction network 840. In addition, the mask deformable decoder module 540 may further include a mask generation network 802 and a sum and normalization modules 812 and 822.

The mask deformable decoder module 540 may obtain final key point coordinates R^{t} and a key point variance V^{t}. In this case, t may be related to the number of neural network units of the mask deformable decoder module 540.

Referring to FIG. 8, the mask generation network 802 may calculate a mask matrix using Equation 1 described above and may block (mask out) a key point having a great variance.

The mask deformable decoder module 540 may obtain k and q by adding Qₜ to P and may use Qₜ as v. In this case, for the first neural network unit of the mask deformable decoder module 540, the query vector and the position vector, which are output by the decoder module 530, and the mask matrix output by the mask generation network 802 may be used as inputs to the self-attention network 810. For the second neural network unit, Qₜ may be the query vector output by the first neural network unit, and P may be the position vector obtained by performing position encoding on the position information output by the first neural network unit. t may be related to the number of neural network units in the mask deformable decoder module.

Thereafter, the sum and normalization module 812 may add the output of the self-attention network 810 to Qₜ and normalize it, and may input the normalized result, the memory vector, and the position information of the previous prediction to the deformable attention network 820. The sum and normalization module 822 may add the output of the deformable attention network 820 to the normalization result of the sum and normalization module 812 and normalize it. An FNN 824 may receive the normalization result of the sum and normalization module 822 and may output a query vector Qₜ₊₁.

The mask deformable decoder module 540 may obtain position offset information of the key point by using the position prediction network 830, may obtain a variance Vₜ₊₁ of the key point by using the variance prediction network 840, and may obtain final position information Rₜ₊₁ by adding the predicted offset information to the position information of the previous prediction. Optionally, the mask deformable decoder module 540 may directly predict the final position information by using the position prediction network 830 without adding the offset information to the position information that is predicted in advance. In this case, for the first neural network unit of the mask deformable decoder module 840, the position information of the previous prediction may be the position information output by the decoder module 530, the second neural network unit of the mask deformable decoder module 540 may be the position information output by the first neural network unit of the mask deformable decoder module 540, and the process may continue in the same manner. The memory vector input to the neural network unit may be the same vector in all inputs.

After obtaining the position information and the variance information of the final output key point, the mask deformable decoder module 540 may select only a key point of which the variance is less than a threshold value according to the given threshold value to effectively block key points that are invisible or difficult to recognize. For example, the threshold value may be set to 0.5 and the threshold value may be adjusted according to the actual need.

In other words, the mask deformable decoder module 540 may generate a mask using the variance information and may remove the influence of an invisible key point on a visible key point in structural prediction. In addition, the mask deformable decoder module 540 may determine a more accurate key point by using the variance of the final output of the network as a criterion for determining the presence of the key point.

In a training step, the key point coordinates and variances output by the three modules, the key point coordinate initialization module 520, the decoder module 530, and the mask deformable decoder module 540, may be included in RLE loss calculation and in an inference step, the output of the final module may be used as a final inference result. In the inference step, the variance information output by the key point coordinate initialization module 520 and the variance information output by the mask deformable decoder module 540 may not be required.

The key point recognition method may improve the recognition accuracy by effectively blocking the interference of an invisible point with structural information learning, which may be achieved with use of the variance.

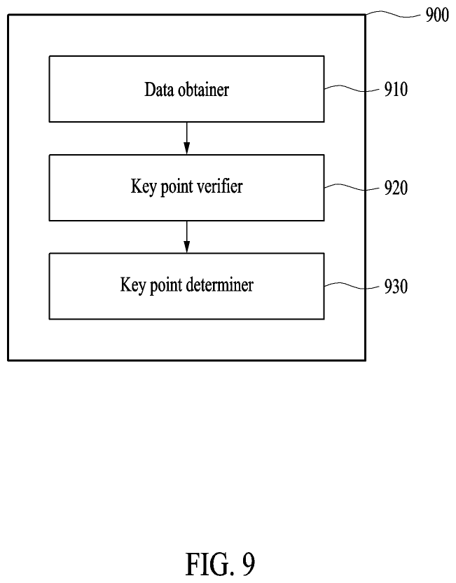

FIG. 9 is a block diagram illustrating a key point detection device according to one or more embodiments.

A key point detection device 900 shown in FIG. 9 is an example and the name and number of components may vary depending on the actual circumstance.

Referring to FIG. 9, the key point detection device 900 may include a data obtainer 910, a key point verifier 920, and a key point determiner 930.

The data obtainer 910 may obtain an initial detection result and first variance information of a key point of a target object in an image. In this case, the detection result may include position information of the key point.

The data obtainer 910 may obtain a target image block including the target object in the image, may obtain feature information of the target image block by extracting a feature from the target image block, and may obtain the initial detection result and the first variance information of the key point of the target object based on the feature information.

When the data obtainer 910 obtains the initial detection result and the first variance information of the key point of the target object based on the feature information, the data obtainer 910 may obtain first position-related information of the key point of the target object by using a first neural network, based on at least one feature of the feature information and may predict the initial detection result and the first variance information of the key point of the target object by using a second neural network, based on the first position-related information and the at least one feature.

In this case, the second neural network may include at least a first self-attention network, a cross-attention network, a first position prediction network, and a first variance prediction network. In this case, the second neural network may include a plurality of neural network units connected in series. Each of the plurality of neural network units may include the first self-attention network, the cross-attention network, the first position prediction network, and the first variance prediction network. An input to the first neural network unit of the plurality of neural network units may be the first position-related information, at least one feature, and a first query vector, and an output of the first neural network unit may be position-related information as an intermediate value, a query vector, and position information and variance information of the key point. In the plurality of neural network units, the following neural network unit of the first neural network unit may use the output of the previous neural network unit and may perform an operation until the last neural network unit outputs the initial detection result and the first variance information.

The data obtainer 910 may generate the first query vector based on the at least one feature, may generate a first feature based on the first query vector and the first position-related information by using the first self-attention network, may generate a second feature based on the first feature and the at least one feature by using the cross-attention network, and may predict the initial detection result and the first variance information based on the second feature by using the first position prediction network and the first variance prediction network.

The key point verifier 920 may perform key point verification on the initial detection result based on the first variance information.

The key point verifier 920 may generate a mask matrix for determining a key point based on the first variance information and may determine a first key point of the target object based on the mask matrix and the initial detection result.

The key point determiner 930 may determine a detection result of the target object based on a result of key point verification.

The key point determiner 930 may obtain a target image block including the target object in the image, may obtain feature information of the target image block by extracting a feature from the target image block, and may predict position information of a final key point of the target object by using the third neural network based on the feature information, the initial detection result, and the first key point.

In this case, the third neural network may include a second self-attention network, a deformable attention network, a second position prediction network, and a second variance prediction network. In this case, the third neural network may include a plurality of neural network units connected in series. Each of the plurality of neural network units may include the self-attention network, the deformable attention network, the second position prediction network, and the second variance prediction network. An input to the first neural network unit of the plurality of neural network units may be the first key point, second position-related information, a second query vector, the feature information, and the initial detection result, and an output of the first neural network unit may be position-related information as an intermediate value, the query vector, the position information and the variance information of the key point, and in the plurality of neural network units, the following neural network unit of the first neural network unit may use the output of the previous neural network unit as an input and may perform an operation until the last neural network unit outputs a final detection result.

The key point determiner 930 may generate a third feature based on the second position-related information and the second query vector, which are output by the second neural network, and the first key point by using the second self-attention network, may generate a fourth feature based on the third feature, the feature information, and the initial detection result by using the deformable attention network, and may predict the position information of the final key point of the target object based on the fourth feature by using the second position prediction network and the second variance prediction network.

The key point determiner 930 may obtain the position information of the key point of the target object based on the fourth feature by using the second position prediction network, may obtain the second variance information of the key point of the target object based on the fourth feature by using the second variance prediction network, may determine a final key point of the target object based on a comparison between the second variance information and a threshold value, and may obtain the position information of the final key point of the target object in the final key point of the target object.

It should be understood that each unit/module of the key point detection device according to the embodiments described herein may be implemented as hardware components and/or software components. One skilled in the art may use, for example, a field-programmable gate array (FPGA) or an application-specific integrated circuit (ASIC) to implement each module depending on the processing performed by each defined unit/module.

The methods according to the above-described embodiments may be recorded in non-transitory computer-readable media including program instructions to implement various operations of the above-described embodiments. The media may also include, alone or in combination with the program instructions, data files, data structures, and the like. The program instructions recorded on the media may be those specially designed and constructed for the purposes of example embodiments, or they may be of the kind well-known and available to those having skill in the computer software arts. Examples of non-transitory computer-readable media include magnetic media such as hard disks, floppy disks, and magnetic tape; optical media such as CD-ROM discs, DVDs, and/or Blue-ray discs; magneto-optical media such as optical discs; and hardware devices that are specially configured to store and perform program instructions, such as read-only memory (ROM), random access memory (RAM), flash memory (e.g., USB flash drives, memory cards, memory sticks, etc.), and the like. Examples of program instructions include both machine code, such as produced by a compiler, and files containing higher-level code that may be executed by the computer using an interpreter. The above-described devices may be configured to act as one or more software modules in order to perform the operations of the above-described example embodiments, or vice versa.

The software may include a computer program, a piece of code, an instruction, or some combination thereof, to independently or uniformly instruct or configure the processing device to operate as desired. Software and data may be stored in any type of machine, component, physical or virtual equipment, or computer storage medium or device capable of providing instructions or data to or being interpreted by the processing device. The software also may be distributed over network-coupled computer systems so that the software is stored and executed in a distributed fashion. The software and data may be stored by one or more non-transitory computer-readable recording mediums.

According to an embodiment, an electronic device may be provided and the electronic device may include at least one processor and at least one memory storing computer-executable instructions, wherein the computer-executable instructions, when executed by the at least one processor, may cause the at least one processor to implement the key point detection method described herein.

Specifically, the electronic device may be broadly defined as a tablet, a smartphone, a smartwatch, or any other electronic devices having a required computing and/or processing ability. The electronic device may include a processor connected via a system bus, a memory, a network interface, and a communication interface. The processor of the electronic device may be used to provide required computing, processing, and/or control abilities. The memory of the electronic device may include a non-volatile storage medium and internal memory. The non-volatile storage medium may store an operating system, a computer program, etc., therein or thereon. The internal memory may provide an environment for the operation of the operating system and the computer program in the non-volatile storage medium. A network interface and a communication interface of the electronic device may be used to connect to or communicate with an external device via a network.

At least some functions of the electronic device or the device provided herein may be implemented by an AI model. For example, at least one of various modules of the device or the electronic device may be implemented by an AI model. An AI-related function may be performed by the non-volatile memory, volatile memory, or the processor.

The processor may include one or more processors. In this case, the one or more processors may be a general-purpose processor (e.g., a CPU, an application processor (AP), etc.) or a graphics-dedicated processing unit (e.g., a GPU and a vision processing unit (VPU)), and/or an AI-dedicated processor (e.g., a neural processing unit (NPU)).

The one or more processors may control processing of input data according to a predefined operation rule or an AI model stored in the non-volatile memory and the volatile memory. The predefined operation rules or AI model may be provided through training or learning.

Here, providing the predefined operation rules or AI model through learning may indicate obtaining a predefined operation rule or AI model with desired characteristics by applying a learning algorithm to a plurality of pieces of training data. The training may be performed by the apparatus or the electronic device itself, in which AI is performed, according to embodiments or by a separate server, device, and/or system.

The AI model may include a plurality of neural network layers. Each layer has a plurality of weight values, and each layer performs neural network calculation by calculating between input data of a corresponding layer (e.g., a calculation result of a previous layer and/or input data of the AI model) and a plurality of weight values of a current layer. The neural network may include, for example, a convolutional neural network (CNN), a deep neural network (DNN), a recurrent neural network (RNN), a restricted Boltzmann machine (RBM), a deep belief network (DBN), a bidirectional recurrent deep neural network (BRDNN), a generative adversarial network (GAN), and a deep Q network, but is not limited thereto.

The learning algorithm may be a method of training a predetermined target device, for example, a robot, based on a plurality of pieces of training data and of enabling, allowing or controlling the target device to perform determination or prediction. The learning algorithm may include, but is not limited to, for example, supervised learning, unsupervised learning, semi-supervised learning, or reinforcement learning.

Each step of the present disclosure may be implemented by using the AI model. The processor of the electronic device may perform preprocessing on the data to convert the data into a format that is suitable for use as an input to the AI model. The AI model may be obtained by training. Here, “being obtained through training” may refer to obtaining the predefined operation rule or the AI model configured to perform a desired feature (or objective) by training a basic AI model with multiple pieces of training data through a training algorithm.

Embodiments of the present disclosure may further provide an electronic device and the electronic device may include at least one processor, and optionally, may further include at least one transceiver coupled to the at least one processor and/or at least one memory, and the at least one processor may be configured to perform operations of the method provided in any optional embodiment herein.

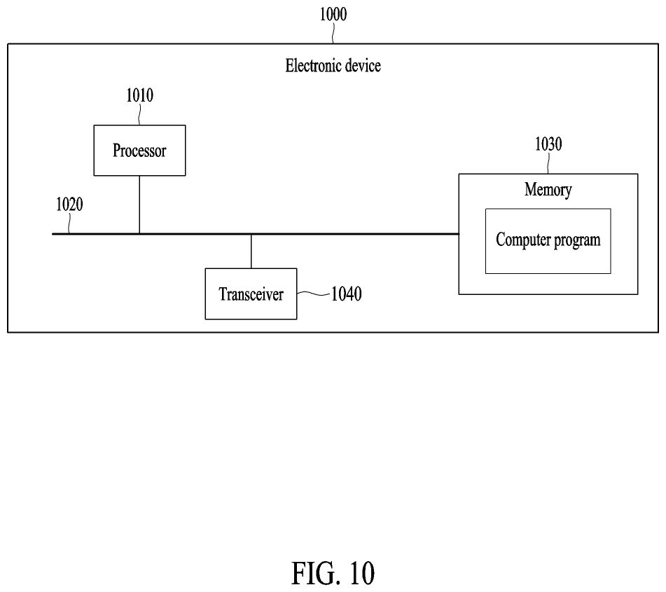

FIG. 10 illustrates an example of an electronic device for detecting a key point according to one or more embodiments.

Referring to FIG. 10, an electronic device 1000 may include a processor 1010 and a memory 1030. The processor 1010 and the memory 1030 may be connected to each other. In this case, the processor 1010 and the memory 1030 may be connected to each other via a bus 1020. Optionally, the electronic device 1000 may further include a transceiver 1040 and the transceiver 1040 may be used for data exchange, such as transmitting and/or receiving data between the electronic device and another electronic device. In the actual application, the numbers of the processor 1010, the memory 1030, and the transceiver 1040 are not limited to one, and it should be noted that the structure of the electronic device 1000 does not limit the embodiment of the present disclosure. Optionally, the electronic device 1000 may be a first network node, a second network node, or a third network node.

The processor 1010 may be a CPU, a general-purpose processor, a DSP, an ASIC, an FPGA, or any other programmable logic units, a transistor logic unit, a hardware component, or a combination thereof. The processor 1010 may implement or execute various exemplary logic blocks, modules, and circuitry described herein. The processor 1010 may be, for example, a combination for implementing a computing function including a combination of one or more microprocessors, a combination of a DSP and a microprocessor, and the like.

The bus 1020 may include a path for transferring information among the components. The bus 1020 may be a peripheral component interconnect (PCI) bus or an extended industry standard architecture (EISA) bus. The bus 1020 may be divided into an address bus, a data bus, and a control bus. For ease of illustration, FIG. 10 illustrates only one bold line, but the bus may not be one or only one type of bus.

The memory 1030 may be read-only memory (ROM) or another type of static storage device for storing static information and instructions, random-access memory (RAM) or another type of dynamic storage device for storing information and instructions, electrically erasable programmable ROM (EEPROM), a compact disc read-only memory (CD-ROM) or other optical disc storages, an optical disc storage (including a compressive optical disc, a laser disc, an optical disc, a digital versatile disc (DVD), a Blu-ray disc, and the like), disk storage media, other magnetic storage devices, or other computer-readable medium that may be used to carry or store a computer program, but the type of the memory 1030 is not limited thereto.

The memory 1030 may be used to store the computer program or computer-executable instructions to implement the embodiment of the present disclosure and may be controlled by the processor 1010. The processor 1010 may be configured to implement the operations shown in the embodiments of the method described above by executing the computer program or computer-executable instructions stored in the memory 1030.

The computing apparatuses, the electronic devices, the processors, the memories, the displays, the information output system and hardware, the storage devices, and other apparatuses, devices, units, modules, and components described herein, including descriptions with respect to respect to FIGS. 1-10, are implemented by or representative of hardware components. As described above, or in addition to the descriptions above, examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit (ALU), a digital signal processor (DSP), a microcomputer, a programmable logic controller, a field-programmable gate array (FPGA), a programmable logic array (PLU), a microprocessor, or any other device or combination of devices that is configured to respond to and execute instructions (e.g., code or coding) in a defined manner to achieve a desired result. In one example, a processor or computer includes, or is connected to, one or more memories storing the instructions or software that are executed by the processor or computer. Hardware components implemented by a processor or computer may execute the instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both, and thus while some references may be made to a singular processor or computer, such references also are intended to refer to multiple processors or computers. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. As described above, or in addition to the descriptions above, example hardware components may have any one or more different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing. Thus, references to a processor herein mean processing circuitry (e.g., circuitry that includes one or more processing element(s) circuits). One or more processors comprising processing circuitry also refers to each processor comprising processing circuitry, as well as some or all of the one or more processors comprising the same processing circuitry. In addition, processors(s) and controller(s), as a non-limiting example, do not mean human processing or human control, but rather, refer to hardware components as described herein, as non-limiting examples.

The methods illustrated in, and discussed with respect to, FIGS. 1-10 that perform the operations described in this application are performed by computing hardware, for example, by one or more processors or computers, implemented as described above implementing the instructions (e.g., computer or processor/processing device readable instructions) or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations. References to a processor, or one or more processors, as a non-limiting example, configured to perform two or more operations refers to a processor or two or more processors being configured to collectively perform all of the two or more operations, as well as a configuration with the two or more processors respectively performing any corresponding one of the two or more operations (e.g., with a respective one or more processors being configured to perform each of the two or more operations, or any respective combination of one or more processors being configured to perform any respective combination of the two or more operations). Likewise, a reference to a processor-implemented method is a reference to a method that is performed by one or more processors or other processing or computing hardware of a device or system.

The instructions or software to control computing hardware, for example, one or more processors or computers, to implement the hardware components and perform the methods as described above may be written as computer programs, code segments, or other executable instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media, and thus, not a signal per se. Thus, references herein to storage media mean storage media hardware, and does not mean to transitory media, nor a signal per se. As described above, or in addition to the descriptions above, examples of a non-transitory computer-readable storage medium include one or more of any of read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as a multimedia card or a micro card (for example, secure digital (SD) or extreme digital (XD)), magnetic tapes, floppy disks, magneto-optical data storage devices, optical data storage devices, hard disks, solid-state disks, and/or any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above and all drawing disclosures, the scope of the disclosure is also inclusive of the claims and their equivalents, i.e., all variations within the scope of the claims and their equivalents are to be construed as being included in the disclosure.

What is claimed is:

1. A method of detecting a key point, the method performed by a computing device and comprising:
obtaining both an initial detection result of detecting a target object in an image and first variance information of a key point of the target object in the image;
performing key point verification on the initial detection result, wherein the key point verification is performed based on the first variance information; and
determining an initial detection result of the target object based on a verification result of the key point verification,
wherein the initial detection result comprises position information of the key point.

2. The method of claim 1, wherein the performing of the key point verification on the initial detection result based on the first variance information comprises:
generating a mask matrix for the determining of the key point based on the first variance information; and
determining a first key point of the target object based on the mask matrix and the initial detection result.

3. The method of claim 1, wherein the obtaining of the initial detection result and the first variance information of the key point of the target object comprises:
obtaining a target image block from the image, the target image block comprising the target object;
obtaining feature information of the target image block by performing feature extraction on the target image block; and
obtaining the initial detection result and the first variance information of the key point of the target object based on the obtained feature information.

4. The method of claim 3, wherein the obtaining of the initial detection result and the first variance information of the key point of the target object based on the feature information comprises:
predicting first position-related information of the key point of the target object by using a first neural network, based on at least one feature of the feature information; and
predicting the initial detection result and the first variance information of the key point of the target object by using a second neural network, based on the first position-related information and the at least one feature.

5. The method of claim 4, wherein the second neural network comprises a first self-attention network, a cross-attention network, a first position prediction network, and a first variance prediction network, and
the predicting of the initial detection result and the first variance information of the key point of the target object by using the second neural network, based on the first position-related information and the at least one feature, comprises:
generating a first query vector based on the at least one feature;
generating a first feature based on the first query vector and the first position-related information by using the first self-attention network;
generating a second feature based on the first feature and the at least one feature by using the cross-attention network; and
predicting the initial detection result and the first variance information based on the second feature by using the first position prediction network and the first variance prediction network.

6. The method of claim 2, wherein the determining of the detection result of the target object based on the verification result of the key point comprises:
obtaining a target image block comprising the target object from the image;
obtaining feature information of the target image block by performing feature extraction on the target image block; and
predicting position information of a final key point of the target object by using a third neural network, based on the feature information, the initial detection result, and the first key point.

7. The method of claim 6, wherein the third neural network comprises a second self-attention network, a deformable attention network, a second position prediction network, and a second variance prediction network, and
the predicting of the position information of the final key point of the target object by using the third neural network, based on the feature information, the initial detection result, and the first key point, comprises:
generating a third feature by using the second self-attention network, based on the first key point, second position-related information output by the second neural network, and a second query vector;
generating a fourth feature by using the deformable attention network, based on the third feature, the feature information, and the initial detection result; and
predicting the position information of the final key point of the target object based on the fourth feature by using the second position prediction network and the second variance prediction network.

8. The method of claim 7, wherein the predicting of the position information of the final key point of the target object based on the fourth feature by using the second position prediction network and the second variance prediction network comprises:
obtaining position information of the key point of the target object based on the fourth feature by using the second position prediction network;
obtaining second variance information of the key point of the target object based on the fourth feature by using the second variance prediction network; and
determining the final key point of the target object based on a comparison between the second variance information and a threshold value and obtaining the position information of the final key point of the target object from the final key point of the target object.

9. The method of claim 5, wherein the second neural network comprises a plurality of neural network units connected in series,
each of the plurality of neural network units comprises the first self-attention network, the cross-attention network, the first position prediction network, and the first variance prediction network,
an input to a first neural network unit of the plurality of neural network units comprises the first position-related information, the at least one feature, and the first query vector,
an output of the first neural network unit comprises position-related information as an intermediate value, a query vector, and position information and variance information of the key point, and
in the plurality of neural network units, a following neural network unit of the first neural network unit uses an output of a previous neural network unit as an input and performs an operation until a last neural network unit outputs the initial detection result and the first variance information.

10. The method of claim 7, wherein the third neural network comprises neural network units connected in series with each other,
each of the neural network units comprises the second self-attention network, the deformable attention network, the second position prediction network, and the second variance prediction network,
an input to a first neural network unit of the neural network units comprises the first key point, the second position-related information, the second query vector, the feature information, and the initial detection result,
an output of the first neural network unit comprises position-related information as an intermediate value, a query vector, and position information and variance information of the key point, and
in the neural network units, a following neural network unit of the first neural network unit uses an output of a previous neural network unit as an input and performs an operation until a last neural network unit outputs a final detection result.

11. A non-transitory computer-readable storage medium storing instructions that, when executed by a processor, cause the processor to perform the method of claim 1.

12. An electronic device for detecting a key point, the electronic device comprising:
one or more processors; and
memory storing instructions,
wherein the instructions, when executed by the one or more processors, cause the electronic device to:
obtain an initial detection result and first variance information of a key point of a target object in an image,
perform key point verification on the initial detection result based on the first variance information, and
determine a detection result of the target object based on a verification result of the key point,
wherein the initial detection result comprises position information of the key point.

13. A device for detecting a key point, the device comprising:
a data obtainer configured to obtain an initial detection result and first variance information of a key point of a target object in an image;
a key point verifier configured to perform key point verification on the initial detection result based on the first variance information; and
a key point determiner configured to determine a detection result of the target object based on a verification result of the key point,
wherein the initial detection result comprises position information of the key point.

14. The device of claim 13, wherein the key point verifier is further configured to:
generate a mask matrix for determining the key point based on the first variance information, and
determine a first key point of the target object based on the mask matrix and the initial detection result.

15. The device of claim 13, wherein the data obtainer is further configured to:
obtain a target image block comprising the target object from the image,
obtain feature information of the target image block by performing feature extraction on the target image block, and
obtain the initial detection result and the first variance information of the key point of the target object based on the feature information.

16. The device of claim 15, wherein the data obtainer is further configured to:
when obtaining the initial detection result and the first variance information of the key point of the target object based on the feature information,
predict first position-related information of the key point of the target object by using a first neural network, based on at least one feature of the feature information, and
predict the initial detection result and the first variance information of the key point of the target object by using a second neural network, based on the first position-related information and the at least one feature.

17. The device of claim 16, wherein the second neural network comprises a first self-attention network, a cross-attention network, a first position prediction network, and a first variance prediction network, and
the data obtainer is further configured to:
generate a first query vector based on the at least one feature,
generate a first feature based on the first query vector and the first position-related information by using the first self-attention network,
generate a second feature based on the first feature and the at least one feature by using the cross-attention network, and
predict the initial detection result and the first variance information based on the second feature by using the first position prediction network and the first variance prediction network.

18. The device of claim 14, wherein the key point determiner is further configured to:
obtain a target image block comprising the target object from the image;
obtain feature information of the target image block by performing feature extraction on the target image block, and
predict position information of a final key point of the target object by using a third neural network, based on the feature information, the initial detection result, and the first key point.

19. The device of claim 18, wherein the third neural network comprises a second self-attention network, a deformable attention network, a second position prediction network, and a second variance prediction network, and
the key point determiner is further configured to:
generate a third feature by using the second self-attention network, based on the first key point, second position-related information output by the second neural network, and a second query vector,
generate a fourth feature by using the deformable attention network, based on the third feature, the feature information, and the initial detection result, and
predict the position information of the final key point of the target object based on the fourth feature by using the second position prediction network and the second variance prediction network.

20. The device of claim 19, wherein the key point determiner is further configured to:
obtain position information of the key point of the target object based on the fourth feature by using the second position prediction network,
obtain second variance information of the key point of the target object based on the fourth feature by using the second variance prediction network, and
determine the final key point of the target object based on a comparison between the second variance information and a threshold value and obtaining the position information of the final key point of the target object from the final key point of the target object.
